(19) United States
(12) Patent Application Publication
(10) Pub. No.: US 2009/0217679 A1
(43) Pub. Date: Sep. 3, 2009

(54) REFRIGERATION COOLING SYSTEM CONTROL

(75) Inventor: Sridharan Raghavachari, Franklin, WI (US)

Correspondence Address: RATHE PATENT & IP LAW, 10611 W. HAWTHORNE FARMS LANE, MEQUON, WI, 53097, US

(73) Assignee: Optidyn Inc., Duluth, GA (US)

(21) Appl. No.: 12/039,731

(22) Filed: Feb. 28, 2008

(51) Int. Cl. F25B 45/00; F25B 7/00; G05B 15/00

(52) U.S. Cl. 62/77; 62/175; 700/275

(57) ABSTRACT

A controller is configured to perform at least one of loading and unloading at least one of a plurality of refrigerant compressors to a refrigeration cooling system based at least upon an enthalpy of circulating refrigerant liquid of the refrigeration cooling system and a rate of change of enthalpy of evaporated refrigerant gas in the refrigeration cooling system.

### CROSS-REFERENCE TO RELATED PATENT APPLICATIONS

The present application is related to co-pending U.S. patent application Ser. No. 11/086,527 filed on Mar. 22, 2005 by Sridharan Raghavachari and entitled MULTIPLE COMPRESSOR CONTROL SYSTEM, the full disclosure of which is hereby incorporated by reference.

### BACKGROUND

Cooling systems are used in a variety of applications such as refrigeration systems and air-conditioning systems. Many cooling systems are energy inefficient.

### BRIEF DESCRIPTION OF THE DRAWINGS

FIG. 1 is a schematically straight and of a refrigeration cooling system and control system according to an example embodiment.

FIG. 2 is a block diagram schematically illustrating control logic for the control system of FIG. 1 according to an example embodiment.

FIGS. 3-10 are graphs comparing performance of a refrigeration cooling system not under control of the control system of FIG. 1 with the performance of the refrigeration cooling system under the control of the control system of FIG. 1.

### DETAILED DESCRIPTION OF THE EXAMPLE EMBODIMENTS

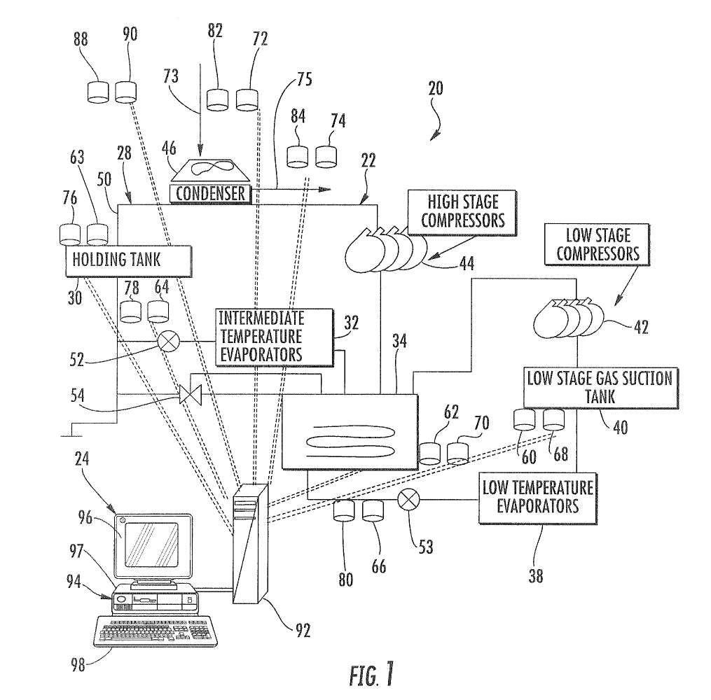

FIG. 1 schematically illustrates controlled cooling apparatus 20 according to one example embodiment. Apparatus 20 includes refrigeration cooling system 22 and control system 24. As will be described hereafter, control system 24 controls various components of refrigeration cooling system 22 to enhance energy efficiency while satisfying cooling objectives for system 22.

Refrigeration Cooling system 22 comprises an arrangement of compressors, condensers, evaporators, and pumps, etc configured to withdraw heat directly or indirectly from a cooled environment and to transmit the withdrawn heat to a remote environment and or atmosphere outside. In the example illustrated, refrigeration cooling system 22 comprises a two-stage cooling system including circulation system 28, holding tank 30, intermediate temperature evaporators 32, intermediate stage gas suction tank 34, low temperature in evaporators 38, low stage gas suction tank 40, low stage compressors 42, high stage compressors 44 and condenser/s 46. Circulation system 28 delivers or directs refrigerant between holding tank 30, intermediate temperature evaporators 32, intermediate stage gas suction tank 34, low temperature evaporators 38, low stage gas suction tank 40, low stage compressors 42, high stage compressors 44 and condenser 46. Circulation system 28 includes piping system 50, expansion valves 52, 53 and level maintenance valve 54. Piping system 50 comprises headers, and piping, plenums and the like configured to direct the flow of refrigerant, whether in gaseous or liquid form. Piping system 50, along with the other components of refrigeration cooling system 22, form a closed circuit refrigerant cooling system in which refrigerant is contained as it is repeatedly compressed, condensed and expanded or evaporated to transfer or conduct heat from one or more cooling areas (in communication with evaporators 32, 38), where heat is absorbed, to condensers 46, where heat is discharged.

Expansion valve 52 (schematically illustrated) comprises one or more expansion valves along conduit 50 between holding tank 30 and intermediate temperature evaporators 32. Expansion valve 52, when actuated or opened, permits liquid refrigerant to expand and flow across intermediate temperature evaporators 32. Likewise, expansion valve 53 (schematically illustrated) comprises one or more expansion valves along conduit 50 between holding tank 30 and low temperature evaporators 38 and/or between intermediate stage gas suction tank 34 and low temperature evaporators 38. Expansion valve 53, when actuated or opened, permits liquid refrigerant to expand and flow across low temperature evaporators 38.

Holding tank 30 comprises one or more tanks configured to store and contain liquid refrigerant. Holding tank 30 is supplied with liquid refrigerant after the refrigerant gas has been compressed and condensed. One example of a refrigerant includes ammonia gas. In other embodiments, other refrigerants may be utilized.

Intermediate temperature evaporators 32 comprise one or more coils, conduits or other structures configured to contain and direct the flow of liquid and refrigerant while facilitating the absorption of heat from the processes to be cooled ing or from the surrounding volume of in such a room to be cooled. Intermediate temperature evaporators 32 receive expanded refrigerant after it is passed across expansion valve 52. In one embodiment, air from the room or other region to be cooled may be directed across the evaporators 32 using a fan. In other embodiments, evaporators 32 may be provided as part of other cooling arrangements.

Intermediate stage gas suction tank 34 comprises a tank or other container configured to collect and store and contain refrigerant from evaporators 32. Most of such refrigerant collected from evaporators 32 may be in gaseous form. Such gaseous refrigerant is contained in tank 34 until taken up by compressors 44. In the example illustrated, tank 34 also receives the gas refrigerant from the low stage gas compressors 42. Tank 34 further contains and supplies liquid refrigerant to low temperature evaporators 38. As noted above, level maintenance valve 54 maintains a predetermined level or amount of liquid refrigerant within tank 34 for supply to low temperature evaporators 38.

Low temperature evaporators 38 comprise one or more coils, conduits or other structures configured to contain and direct the of refrigerant while facilitating the absorption of heat from the processes to be cooled or from the surrounding volume in such a room to be cooled by the ing. Low temperature evaporators 38 receive expanded refrigerant after it is passed across expansion valve 53. In one embodiment, air from the room or other region to be cooled may be directed across the evaporators 38 using a fan. In other embodiments, evaporators 38 may be provided as part of other cooling arrangements.

Low stage gas suction tank 40 comprises a tank or other container configured to collect and to act as a buffer tank to dynamically store and contain refrigerant from evaporators 38 until such evaporated refrigerant is taken up by low stage compressors 42. In the example illustrated, tank 40 includes a suction mechanism for drawing evaporated refrigerant from evaporators 38 and directing the refrigerant to compressors 42.

Low stage compressors 42 comprise one or more compressors configured to receive gaseous refrigerant and to compress the gaseous refrigerant to higher pressure. Compressed refrigerant is discharged from low stage compressors to intermediate gas suction tank 34. In one embodiment, low stage compressors 42 may comprise reciprocating, rotary screw, centrifugal, scroll or vane type compressors. Each compressor is specified load capacity and a specified maximum discharge pressure. The discharge pressures of compressors 42 are adjustable within some range up to the specified maximum discharge pressure. In another embodiment, one or more of the compressors 42 have a fixed discharge pressure. In one embodiment, compresses 42 have controllable slide valves for adjusting an inlet volume of such compressors. Prime movers for such compressors 42 may be driven by electricity, fossil or other fuels, or steam, for example. Compressors 42 may comprise any combination of types, makes or models of compressors.

High stage compressors 44 are similar to low stage compressors 42 but are configured to compress gaseous refrigerant to a greater pressure level. High stage compressors 44 gaseous refrigerant from intermediate stage gas suction tank 34 and discharge compressed gaseous refrigerant to condenser/s 46. Like compressors 42, compressors 44 may comprise reciprocating, rotary screw, centrifugal, scroll or vane type compressors each compressor is specified by load (TR or Volume rate) capacity and a specified maximum discharge pressure. The discharge pressures of compressors 44 are adjustable within some range up to the specified maximum discharge pressure. In another embodiment, one or more of the compressors 44 have a fixed discharge pressure. Prime movers for such compressors 44 may be driven by electricity, fossil or other fuels, or steam, for example. Compressors 44 may comprise any combination of types, makes or models of compressors.

Condensers 46 comprise one more devices configured to receive compressed refrigerant gas and to extract heat from such refrigerant. In one embodiment, condenser 46 comprises one or more in parallel condenser coils through which the compressed refrigerant flows and from which heat is extracted. In one embodiment, condenser 46 may extract heat using one or more fans. In one embodiment, condenser 46 may comprise an evaporative condenser in which water showered upon the coils, wherein the water vaporizes and mixes with the ambient air. In this case, the latent heat of vaporization of the water is supplied by the hot refrigerant inside the condenser tubes. Air force on the outside of the evaporative condensers carries evaporated water vapor from the condenser surface to the ambient air. In another embodiment, condenser 46 may comprise a direct heat transfer condenser. In one embodiment, heat extraction may be performed by directing water across such coils, wherein the water is heated while extracting heat from the gas refrigerant surrounding the outside of the tubes. For example, in one embodiment, condenser 46 may include one or more water cooling towers. In other embodiments, other mechanism for devices may be utilized to extract heat from the refrigerant (cool and condense the compressed refrigerant). The condensed refrigerant is directed to the holding tank 30 via conduit 50, ready to absorb heat once expanded across one or more of expansion valve 52, 53 and directed across evaporators 32, 38.

Control system 24 comprises a system or arrangement of sensors and one or more controllers that are configured to monitor cooling demands and various parameters of refrigerant cooling system 22 and the environment of cooling system 22. In particular, control system 24 is configured to receive and store various analog (pressures, temperatures, flows etc. and digital signals (compressor on/off etc.) and manually in put data (such as compressor parameters, temperature set points etc. Control system 24 is programmed to compute dynamically the total enthalpy of circulating liquid refrigerant of the cooling system and a rate of change of the enthalpy of the evaporated refrigerant gas contained in cooling system 22. Based upon such values, control system 24 adjusts the operating parameters of cooling system 22 to reliably satisfy cooling demands while enhancing energy efficiency. In one embodiment, cooling system 24 controls the loading and unloading of compressors 42 and 44 to satisfy cooling demands while enhancing energy efficiency. In other embodiments, cooling systems 24 may control and adjust other operating parameters of cooling system 22 as well.

Control system 24 generally includes pressure transmitters 60, 62 and 63, temperature transmitters 64, 66, 68, 70, 72, 74 and, flow transmitters 78, 80, 82 and 84, wet bulb temperature transmitter 88, dry bulb temperature transmitter 90, variable frequency drive 92 and controller 94. Pressure transmitters 60, 62 and 63 comprise devices configured to sense pressure of refrigerant. Transmitter 60 is retrofitted on the low stage gas suction tank 40 and senses and detects the pressure of gaseous refrigerant in tank 40. Transmitter 62 is retrofitted on the intermediate stage gas suction tank 34 and senses the pressure of gaseous refrigerant in tank 34. Pressure transmitter 3 is retrofitted or otherwise connected to the inlet side of holding tank 30 and is configured to sense or detect the pressure of condensation of holding tank 30.

Temperature transmitters 64, 66, 68, 70, 72, 74 and comprise devices configured to sense and transmit temperatures of refrigerant. Transmitter 64 is retrofitted on a liquid outlet line of holding tank 30 and senses the temperature of the liquid refrigerant discharged from holding tank 30. Transmitter 66 is retrofitted at an upstream side of expansion valve 53 and senses & transmits the temperature of liquid refrigerant from holding tank 30 and from tank 34 prior to the liquid refrigerant passing through expansion valve 53. Transmitter 68 is retrofitted on low stage gas suction tank 40 and senses the temperature of gaseous refrigerant in tank 40. Transmitter 70 is retrofitted on intermediate stage gas suction tank 34. Transmitter 72 is retrofitted to the water line/s to condenser/46 and senses the temperature of the inlet water being supplied to condenser/s 46. Transmitter 74 is retrofitted to an outlet water line of condenser 46 and senses the temperature of the return or remaining water that has passed through condenser 46. Transmitter 76 is retrofitted to holding tank 30 and senses the condensing temperature of the refrigerant in condenser/s 46 as well as the holding temperature of the refrigerant in tank 30.

Flow transmitters 78, 80, 82 and 84 comprise the sensors configured to detect and transmit the volume/mass flow of the refrigerant liquid and or gas. Flow transmitter 78 is retrofitted or otherwise connected to the refrigerant liquid outlet line of holding tank 30 so as to detect and transmit the total flow of liquid refrigerant from holding tank 30. Flow transmitter 80 is retrofitted or otherwise connected to an upstream or inlet side of expansion valve 53 so as to detect t and transmit the flow of liquid refrigerant through expansion valve 53 prior to expansion of such liquid refrigerant. Flow transmitter 82 is retrofitted and or connected to the water inlet line of condenser 46 and is configured to sense and transmit the flow of water to condenser 46. Flow transmitter 84 is retrofitted or otherwise connected to the water outlet line of condenser 46 and is configured to sense and transmit the flow of water from condenser 46.

Wet bulb temperature transmitter 88 comprises a sensor configured to sense and transmit a wet bulb temperature of ambient air proximate condenser 46. Dry bulb temperature transmitter 90 comprises a sensor configured to measure and transmit a dry bulb temperature of ambient air proximate condenser 46. Transmitters 88 and 90 enable controller 94 to adjust operation of cooling system 22 based upon the ambient conditions such as the temperature, humidity, etc of the air which may affect the ability of heat to be extracted from liquid refrigerant passing through condenser 46.

Variable frequency drive 92 comprises a device associated with controller 94 that is configured to receive signals or data from the sensors or transmitters to a control system 24 and, based upon optimization algorithms and analysis performed by one or both of drive 92 or controller 94, is further configured to transmit control signals that would selectively increase or decrease the volume of the refrigerant gas being compressed prior to condensation and accordingly load and or unload a selected one of compressors 42, 44 operating at a partial load (a trim compressor) at a variable frequency. In other embodiments, drive 92 may be incorporated into or as part of controller 94. In still other embodiments, where the one or more trim compressors are variably controlled by adjusting controllable slide valves, drive 92 may be omitted.

Controller 94 comprises a processing unit configured to receive input or data from transmitters 64-90 as well as inputs from the human operators, and to generate control signals based upon such data directing the operation of compressors 42, 44 and condenser 46. For purposes of this application, the term “processing unit” shall mean a presently developed or future developed processing unit that executes sequences of instructions. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, controller 94 may be embodied as part of one or more application-specific integrated circuits (ASICs). Unless otherwise specifically noted, the controller is not limited to any specific combination of hardware circuitry and software, nor to any particular source for the instructions executed by the processing unit.

As shown by FIG. 1, in one embodiment, controller 94 may comprise a computer having a monitor 96, a hard drive 97 and user input 98. Monitor 96 provides one mechanism by which data or information may be communicated to a person. Hard drive 97 includes processing circuitry, memory and ports for portable memory reading and writing (disk drive, USB port, memory card reader and the like). User input 98 comprises a keyboard, mouse, microphone and associated speech recognition software, stylus, touch screen or other device configured to facilitate entry of information to controller 94. In another embodiment, controller 94 may have other configurations or may be connected to a remote user interface such as via a network or the Internet.

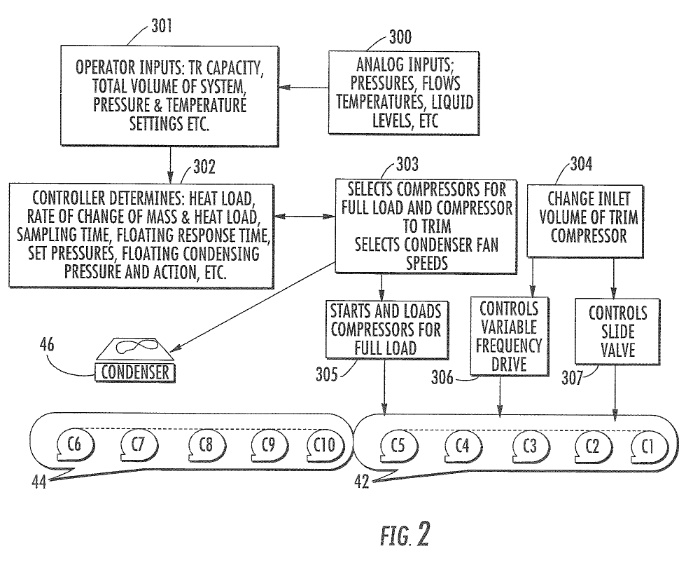

FIG. 2 is a block diagram illustrating one example of control logic according to an example embodiment. As shown in block 300 of FIG. 2, drive 92 and controller 94 receives various analog inputs including low stage gas temperature from transmitter 68, low stage gas pressure from transmitter 60, intermediate or high stage gas temperature from transmitter 70, intermediate or high stage gas pressure from transmitter 62, refrigerant flow from flow transmitter 78, refrigerant temperature from temperature transmitter 64, refrigerant flow from transmitter 80, refrigerant temperature from transmitter 66, holding tank pressure and temperature from transmitter 63 and 85, respectively, condenser water/air outflow from transmitters 84, condenser water outlet temperature from transmitter 74, condenser water/air inlet flow from transmitter 82, condenser water/air inlet temperature from transmitter 72, a wet bulb temperature from transmitter 88 and ambient dry bulk temperature from transmitter 90. In addition, controller 94 may also receive inputs regarding the level of liquid refrigerant in holding tank 30 and tank 32.

As shown in FIG. 2, block 301, controller 94 additionally receives various operator inputs. For example, controller 94 may receive compressor information such as kW, ton refrigeration (TR) rating, service factor, start delay, rest delay and stop delay information for each compressor. Controller 94 may also receive information regarding the volumes in which gaseous and liquid refrigerant is contained. For example, controller 94 may receive information regarding the volume of various sections of segments of conduit 50 as well as the various tanks 30, 34 and 40 of cooling system 22. Controller 94 may also receive information regarding the type or refrigerant used in various operational parameters such as a system set temperature and pressure for each stage. Operator input additionally includes minimum and/or maximum levels of liquid refrigerant in the various liquid holding tanks 30, 34, internal size and geometry of the holding tanks, overriding set points and limits of the variable frequency drives 92. Additional analog or operator input values may also be provided to controller 94 in other embodiments.

FIG. 2, blocks 302-307 are performed by controller 94 for each stage of the cooling system. In the example illustrated, block 302-307 are performed by controller 94 (utilizing drive 92) for each of the low-temperature stage (area being cooled by low-temperature evaporators 38) and the intermediate temperature stage (the area being cooled by intermediate temperature in evaporators 32). As shown by block 302, for each stage, controller 94 dynamically determines the instant thermal content or load (enthalpy), a dynamic rate of change of thermal load (rate of change of enthalpy), a response time and the immediate future thermal load (enthalpy). To determine the immediate future load or enthalpy for the low temperature stage, controller 94 utilizes the determined current enthalpy and the rate of change of enthalpy. To determine the response time (the time at which additional gaseous refrigerant must be compressed and condensed to refrigerant in order to meet the cooling demands at the particular stage or cooled area or the time at which the amount of gaseous refrigerant being compressed and condensed may be reduced while still satisfying the cooling demands at the particular stage or cooled area), controller 94 utilizes the current enthalpy for the particular stage, the immediate future enthalpy for the particular stage and the response times of the various available compressors for the particular stage.

As shown by block 303, based upon the determined the instant thermal content or load (enthalpy), a dynamic rate of change of thermal load (rate of change of enthalpy), a response time and the immediate future thermal load (enthalpy), controller 94 selects a combination of compressors for the particular stage that together, have a total capacity, that will closely approximate, but generally not exceed, the immediate future thermal load. Such compressors (base compressors) are operated at full load. Controller 94 will also select one of the remaining compressors for the particular stage as a partially loaded or trim compressor. Only one compressor serves as a partially loaded compressor for each stage at any moment in time. The partial loading of the selected compressor may be enabled either by drive 92 or compressor's own volumetric control or a combination of both.

As indicated by blocks 304 and 305 in FIG. 2, once the full load compressors and the trim compressor are selected for each stage, controller 94 will generate control signals initiating the loading of such compressors based upon the determined response time which is in turn based upon the rate of change of the immediate future cooling load and the lead time of each of the selected full load and trim compressors. For example, if each of the selected full load and trim compressors must be started and loaded in one minute in order to match the thermal load requirements or demands for a particular stage given the determined immediate future thermal load, controller 94 will generate control signals initiating the loading to the selected full load and trim compressors at the appropriate time such that each compressor is loaded at approximately the one minute mark. For example, if one compressor has a response time of 20 seconds, controller 94 will initiate loading of the compressor in 40 seconds. If another of the selected compressors has a response time of 25 seconds, controller 94 will initiate loading of this compressor in 35 seconds. This process of selecting particular combinations of full load or base compressors and partial load or trim compressors for each stage is dynamically performed and repeated over time depending upon changes in the cooling load demands for the different areas being cooled by the different cooling stages.

As shown by blocks 304, 306 and 307 in FIG. 2, with respect to the selected partial load or trim compressor for each stage, controller 94 will vary the inlet volume of the trim compressor to satisfy the remaining cooling load that is not satisfied by the selected full load compressors. As shown by block 306, in one embodiment, controller 94 generates control signals directing drive 92 to vary the frequency of the trim compressor. As indicated by block 307, controller 94 may also, or alternatively, generate control signals to control the slide valve of the selected trim compressor to vary its discharge pressure.

As shown by block 303, controller 94 may further adjust the operational parameters of condenser 46 which may permit controller 94 to further adjust the operation of the compressors to enhance energy efficiency. Likewise, controller 94 may adjust the inlet volume or discharge pressure of one or more the compressors to adjust to the condensing pressure in condenser 46, which again is determined dynamically from the measured ambient wet bulb and dry bulb temperatures through transmitters 88 & 90. In addition, controller 94, in some embodiments, may adjust the operational parameters of condenser 46, such as by adjusting the number of fans or fan speed of condenser 46 which may allow controller 94 to also adjust the particular discharge pressure or inlet volume of one or more of the selected base & trim compressors. By increasing the ability of condenser 46 to extract heat, such as by increasing the number of fans or increasing their speed, the discharge pressure of all the selected compressors may be lowered when the ambient conditions permit so while still satisfying the cooling load demands. In one embodiment, controller 94 controls the variable parameters of condenser 46 as well as the inlet volume or discharge pressure of one or more of the selected trim compressors for enhanced energy efficiency. In particular, based upon a known energy consumption of such fans and the known or determined differences in the amount of energy consumed by the compressor to operate at a different discharge pressures or set pressures, controller 94 may optimize the parameters of each. In other words, controller 94 may select a particular combination of condenser fans at selected speeds and may select a discharge pressure appointed for the compressor to optimize or at least enhance energy efficiency.

In addition to adjusting the inlet volume and or discharge pressure of one or more selected compressors based upon the controllable variables or parameters of condenser 46, controller 94 may also adjust the inlet volume or discharge pressure of the one or more (transient only) selected trim compressor based upon environmental conditions which also impact the ability of condenser 46 to extract heat and condense the gaseous refrigerant. For example, in situations where cooling system 22 is in a location having a seasonal climate, the ability of condenser 46 to extract heat from the refrigerant may greatly vary depending upon ambient outside temperature and humidity. Based upon the detected outside temperature and humidity from transmitters 88, 90, controller 94 adjusts the inlet volume or discharge pressure of the one or more selected trim compressors for enhanced energy efficiency. For example, in response to a more humid and/or warmer condensing environment, controller 94 may increase the discharge pressure of the selected compressors for a given cooling load. Alternatively, in response to a more dry and/or cooler condensing environment, controller 94 may lower the discharge pressure of one of more selected compressors for the same given heat load.

In the particular example illustrated, cooling system 22 includes two stages: a low temperature evaporator stage and an intermediate temperature evaporator stage. For the low temperature evaporator stage, controller 94 determines the instant thermal content or load (enthalpy), a dynamic rate of change of thermal load (rate of change of enthalpy), a response time and the immediate future thermal load (enthalpy) for the low stage. The enthalpy of the refrigerant gas is determined using the temperature and pressure of the refrigerant gas from transmitters 60 and 68 in conjunction with the input or determined volume containing the gas. In the example illustrated, gas refrigerant is contained in tank 40, portions of conduit 50 from tank 40 to compressors 42.

The enthalpy of the liquid refrigerant is determined using the flow lbs/min, and temperature of refrigerant (from flow transmitters 78 80 and temperature transmitters 64, 66. The total enthalpy is the sum of the enthalpy of the gas refrigerant and the liquid refrigerant. In some embodiments, the total enthalpy may be estimated using just the enthalpy of the liquid refrigerant since the enthalpy of the gas refrigerant may comprise a small percentage of the total enthalpy.

To determine the enthalpy for the low temperature stage, controller 94 utilizes data from transmitters 66, 80, 60 and 68. To determine the rate of change of enthalpy for the low temperature stage, controller 94 utilizes data from transmitters 60 and 68.

To determine the enthalpy for the intermediate temperature stage, controller 94 utilizes data from transmitters 64, 78, 62, 70 as well as the determined volume of refrigerant gas in tank 34 (based upon a sensed level of liquid refrigerant and tank 34 and the known volume of tank 34 and open piping or conduit extending from tank 34). The enthalpy of the refrigerant gas is determined using the temperature and pressure of the refrigerant gas from transmitters 62 and 70 in conjunction with the input or determined volume containing the gas, portions of conduit from compressors 42 to tank 34, portions of conduit 50 from compressors 44 to condenser 46 and portions of tank 34 not occupied by liquid refrigerant. Since the volume of liquid refrigerant in tank 34 is measured and transmitted to controller 94, controller 94 may determine the instant volume of gas in tank 34. To determine the rate of change of enthalpy for the intermediate temperature stage, controller 94 utilizes data from transmitters 60 and 68 as well as the determined volume of refrigerant gas in tank 34 based upon a sensed level of liquid refrigerant and tank 34 and the known volume of tank 34 and open piping or conduit extending from tank 34. To determine the immediate future load or enthalpy for the intermediate temperature stage, controller 94 utilizes the determined current enthalpy and the rate of change of enthalpy. To determine a response time (the time at which the inlet gas volume to the running compressors is to be increased or decreased while still meeting the cooling demands at the low temperature stage or cooled area), controller 94 utilizes the current enthalpy for the intermediate temperature stage, the immediate future enthalpy the intermediate temperature stage, the capacities of the compressors 44 and the response times of the various available compressors 44.

In one embodiment, controller 94 validates the determined heat load or enthalpy against the amount of heat being extracted by condenser 46. The amount of heat extracted by condensers 46 may be determined from the information from transmitters 72 and 82 and transmitters 74, 84. The amount of the extracted may approximate the enthalpy. In other embodiments, this validation may be omitted.

In the example illustrated, controller 34 is configured to operate in either a set pressure mode or a floating pressure mode, as selected by an operator. In the set pressure mode, a minimum pressure is maintained in tank 34 to facilitate defrosting or other requirements. In the floating pressure mode, controller adjustably controls the pressure in tank 34 for energy savings. For example, it has been found that energy savings is achievable by maintaining the pressure with tank in proportion to the condensing pressure and the pressure of low stage gas suction tank 40. In one embodiment, the pressure in tank 40 is maintained so as to be equal to the square root of the product of the condensing pressure and the low stage gas suction tank pressure. Since the condensing pressure and the low stage gas suction tank pressure may vary, so will the controlled pressure of tank 34.

In the particular example illustrated, refrigeration cooling system 22 includes two stages: a low temperature evaporator stage and an intermediate temperature evaporator stage. For the low temperature evaporator stage, controller 94 determines the instant thermal content or load (enthalpy), a dynamic rate of change of thermal load (rate of change of enthalpy), a response time and the immediate future thermal load (enthalpy) for the low stage. The enthalpy of the refrigerant gas is determined using the temperature and pressure of the refrigerant gas from transmitters 60 and 68 in conjunction with the input or determined volume containing the gas. In the example illustrated, gas refrigerant is contained in tank 40, portions of conduit 50 from tank 40 to compressors 42.

The enthalpy of the liquid refrigerant is determined using the flow (lbs/min) and temperature of refrigerant (from flow transmitters 78 and 80 and temperature transmitters 64, and 66. The total enthalpy is the sum of the enthalpy of the gas refrigerant and the liquid refrigerant. In some embodiments, the total enthalpy may be estimated using just the enthalpy of the liquid refrigerant since the enthalpy of the gas refrigerant may comprise a small percentage of the total enthalpy.

To determine the enthalpy for the low temperature stage, controller 94 utilizes data from transmitters 66, 80, 60 and 68. To determine the rate of change of enthalpy for the low temperature stage, controller 94 utilizes data from transmitters 60 and 68.

To determine the enthalpy for the intermediate temperature stage, controller 94 utilizes data from transmitters 64, 78, 62, 70 as well as the determined volume of refrigerant gas in tank 34 (based upon a sensed level of liquid refrigerant and tank 34 and the known volume of tank 34 and open piping or conduit extending from tank 34). The enthalpy of the refrigerant gas is determined using the temperature and pressure of the refrigerant gas from transmitters 62 and 70 in conjunction with the input or determined volume containing the gas, portions of conduit from compressors 42 to tank 34, portions of conduit 50 from compressors 44 to condenser 46 and portions of tank 34 not occupied by liquid refrigerant. Since the volume of liquid refrigerant in tank 34 is measured and transmitted to controller 94, controller 94 may determine the instant volume of gas in tank 34. To determine the rate of change of enthalpy for the intermediate temperature stage, controller 94 utilizes data from transmitters 60 and 68 as well as the determined volume of refrigerant gas in tank 34 based upon a sensed level of liquid refrigerant and tank 34 and the known volume of tank 34 and open piping or conduit extending from tank 34. To determine the immediate future load or enthalpy for the intermediate temperature stage, controller 94 utilizes the determined current enthalpy and the rate of change of enthalpy. To determine a response time (the time at which the inlet gas volume to the running compressors is to be increased or decreased while still the meeting the cooling demands at the low temperature stage or cooled area), controller 94 utilizes the current enthalpy for the intermediate temperature stage, the immediate future enthalpy the intermediate temperature stage, the capacities of the compressors 44 and the response times of the various available compressors 44.

In one embodiment, controller 94 validates the determined heat load or enthalpy against the amount of heat being extracted by condenser 46. The amount of heat extracted by condensers 46 may be determined from the information from transmitters 72 and 82 and transmitters 74, 84. The amount of the extracted may approximate the enthalpy. In other embodiments, this validation may be omitted.

Overall, controller 94 performs one or more of the following functions. First, controller 94 selects optimal combinations of base, full load compressors and a single trim compressor at each stage and also determines an optimal start time for loading of each of the selected compressors based upon a predicted or forecasted future cooling load which is determined based upon an existing enthalpy for the particular stage and the rate of change of enthalpy for the particular stage.

Second, controller 94 adjusts operational parameters of condenser 46 based upon existing ambient conditions (temperature and humidity) in combination with a predicted or forecasted future cooling load which is determined based upon an existing enthalpy for the particular stage and the rate of change of enthalpy to conserve energy.

Third, controller 94 controls the condensing rate such as by controlling the number of condensers online or such as by controlling fan speed of the condensers so as to maintain minimum pressure requirements for defrosting or for circulation of refrigerant. For example, controller 94 may decrease the condensing rate (lower fan speed or reduce the number of condensers online) to ensure that the minimum pressure of gaseous refrigerant is maintained.

Fourth, controller 94 further adjusts or controls interstage pressure of refrigerant within tank 34. Such adjustment is based upon the condensing pressure at condenser 46 and the low stage pressure at tank 40. In particular, the adjustment is based upon the square root of the product of the condensing pressure at condenser 46 and the low stage pressure at tank 40.

The following is an example comparing performance of refrigeration cooling system 22 riot under control of control system 24 with the performance of refrigeration cooling system 22 under the control of control system 24. In the particular example described, refrigeration cooling system 22 is in the meat processing & packing industry facility. The particular facility requires Minus 40 F (−40 F) for the process area. It requires Plus 17 F (17 F) for the packing and ware house area.

### 1. Cooling System 22 not Under Control of Control System 24

1.1. LOW STAGE COMPRESSORS:
Table 1.1 lists the compressors included in the low stage compressor group 42:

TABLE 2.1

| | HP | FULL LOAD | TR |
|---|---|---|---|
| COMPRESSOR # | RATING | KW | RATING |
| C1 | 300 | 270 | 200 |
| C2 | 350 | 315 | 240 |
| C3 | 450 | 405 | 310 |
| C4 | 250 | 225 | 175 |
| C5 | 150 | 135 | 110 |

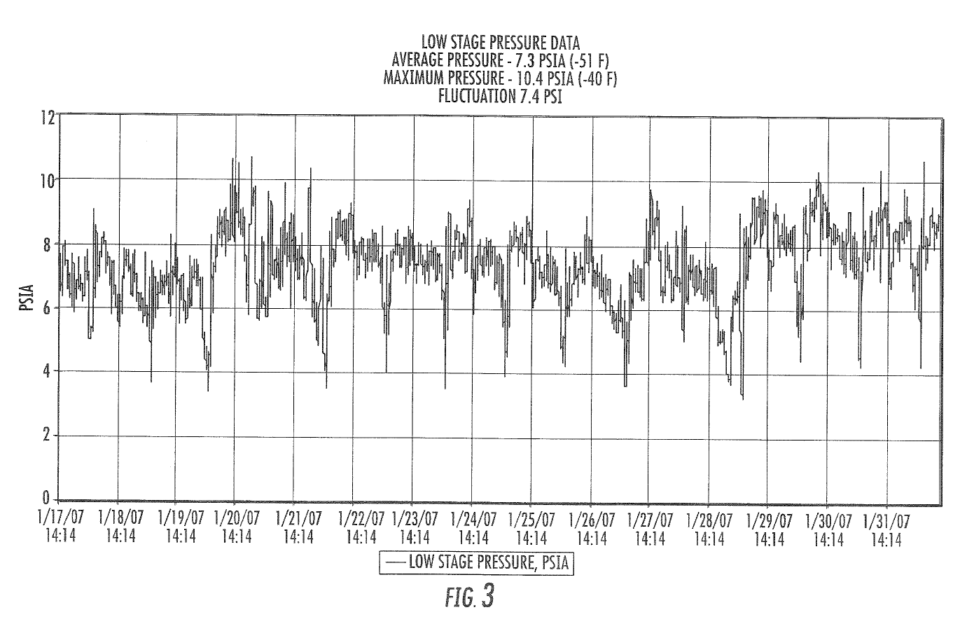

1.1.1. Low stage process requires a temperature of minus 45 (−45 F) degree Fahrenheit, corresponding to a saturation pressure (of Ammonia refrigerant) of 8.92 PSIA. The compressors are set to maintain a suction pressure of 8.0 PSIA (corresponding to a saturation temperature of minus (−) 48.5 F, in the low stage suction tank 40. FIG. 3 illustrates the actual pressure reading in the tank 40 over a period of fifteen days.
1.1.2. Compressors are controlled by stand alone individual controller of each compressor's “start/load/mod u late/stop” controller.
1.1.3. All low stage compressors under group 42 are controlled through one or more of the following methods:
   1.1.3.1. Mechanical loading and unloading of the individual compressors based on the suction pressure or process temperature
   1.1.3.2. Modulating controls of the individual compressors using variable volume control by inlet throttling and or inlet port restrictions also based on suction pressure
1.1.4. One or more compressors may start and load when the pressure goes above the set pressure. Similarly one or more compressors may start modulating the inlet volume/s by opening the slide valve. As a result almost all the compressors are operating at various fractions of the full load capacities resulting in more energy consumption.
1.2. HIGH STAGE COMPRESSORS:
Table 1.2 lists the compressors included in the high stage compressor group 44:

TABLE 1.2

| | HP | FULL LOAD | TR |
|---|---|---|---|
| COMPRESSOR # | RATING | KW | RATING |
| C6 | 600 | 540 | 550 |
| C7 | 700 | 630 | 630 |
| C8 | 700 | 630 | 650 |
| C9 | 600 | 540 | 570 |
| C10 | 450 | 405 | 480 |

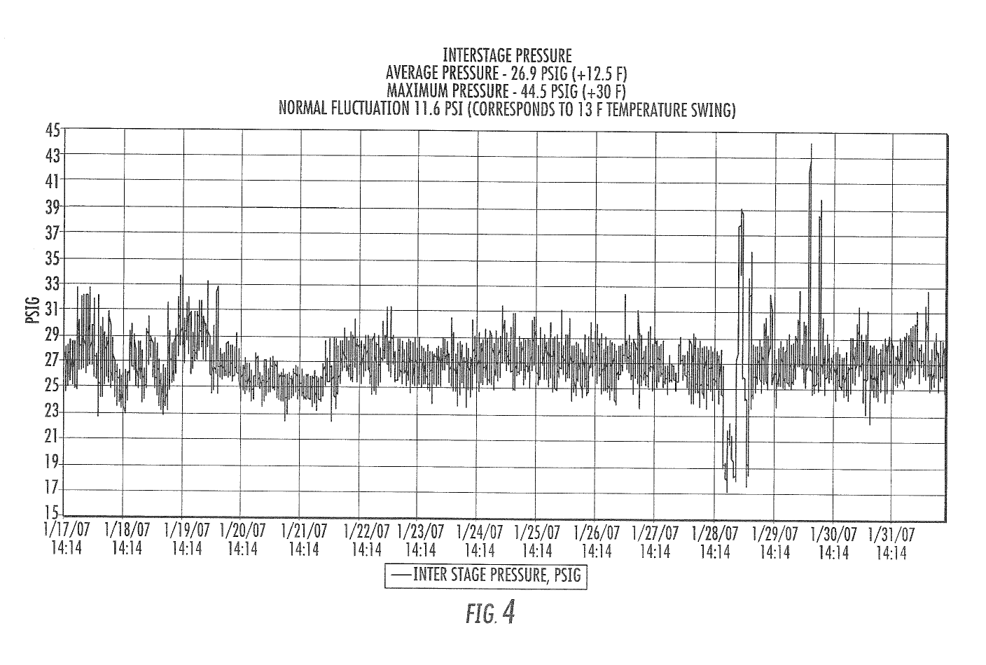

1.2.1. High stage process requires a temperature of 17 degree Fahrenheit (F), corresponding to a saturation pressure (of Ammonia refrigerant) of 45 PSIA (˜30 PSIG). The compressors are set to maintain a suction pressure of 30 PSIG (corresponding to a saturation temperature of 17 F), in the high stage suction tank 34. FIG. 4 illustrates the actual pressure reading in the tank 34 over a period of fifteen days.
1.2.2. Compressors are controlled by stand alone individual controller of each compressor's “start/load/mod u late/stop” controller.
1.2.3. All high stage compressors under group 44 are controlled through one or more of the following methods:
   1.2.3.1. Mechanical loading and unloading of the individual compressors based on the suction pressure or process temperature
   1.2.3.2. Modulating controls of the individual compressors using variable volume control by inlet throttling and or inlet port restrictions also based on suction pressure
1.2.4. One or more compressors may start and load when the pressure goes above the set pressure. Similarly one or more compressors may start modulating the inlet volume/s by opening the slide valve/s when the pressure goes below the set point. As a result almost all the compressors are operating at various fractions of the full load capacities resulting in more energy consumption.
1.3. CONDENSERS
The compressed gas from the high stage compressors are condensed in the six evaporative condensers 46.
   1.3.1. An evaporative condenser is a heat exchanger in which water is showered on the outside of the tube coil and the compressed refrigerant gas circulates through the inside of the coil tubes. The hot compressed gas supplies the latent heat of vaporization for the showered water. The water vaporizes and mixes with the ambient air. The refrigerant gas gets condensed and collects in the holding tank 30. Air is forced on the outside of the evaporative condensers by the condenser fans to carry the moisture vapor from the condenser surfaces to the ambient air.
   1.3.2. CONDENSER FANS:
   Table 1.3 lists the condenser fan motors:

TABLE 1.3

| CONDENSER # | FAN HP | FULL LOAD KW |
|---|---|---|
| CON 1 | 60 | 54 |
| CON 2 | 50 | 45 |
| CON 3 | 50 | 45 |
| CON 4 | 40 | 36 |
| CON 5 | 60 | 54 |
| CON 6 | 50 | 45 |

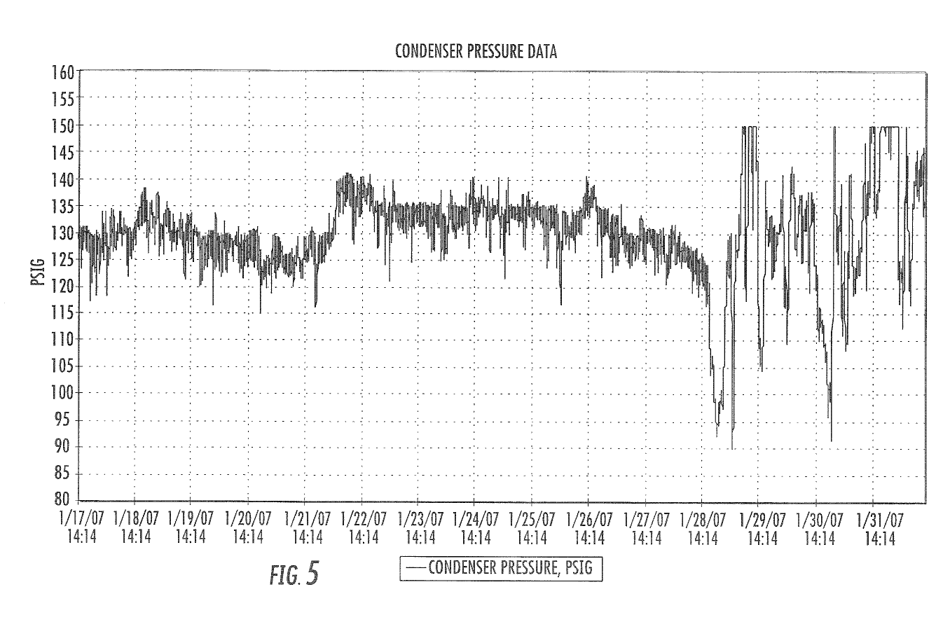

1.3.3. Condensing pressure varies with the condensing temperature. Condensing temperature is influenced by the ambient wet & dry bulb temperatures, indicators of the saturation level of the humidity in the air. The lower the ambient temperature, the higher the rate of evaporation of the water and the condensation of the refrigerant. In the example under chapter 2, condensing temperature (and pressure) is controlled by adding or removing the number of condensers on line. FIG. 5 illustrates the actual condenser pressure reading over a period of fifteen days.
1.4. All the controls described above are designed for proper functioning for maintaining the process temperatures; they do not necessarily include energy performance optimization

### 2. Energy Analysis of Example not Under Control of Control System 24

2.1. Energy, Ton Refrigeration (TR) and Pressure Data
Table 2.1 lists the measured operational data as weekly averages for both stages of compressors as well as the condensers. The data includes average kWs of motors measured; pressures at the various stages including condensers', and TR arrived from published charts.

TABLE 2.1
ENERGY ANALYSIS - PRIOR ART
LOW STAGE

| | FULL | | ACTUAL | % | % | | |
|---|---|---|---|---|---|---|---|
| | LOAD | TR | LOAD | ELECTRIC | TR | ACTUAL | |
| COMP. # | kW | RATING | kW | LOAD | LOAD | TR | kWhrs/year |
| C1 | 270 | 200 | 230 | 85% | 70% | 140 | 2,014,800 |
| C2 | 315 | 240 | 220 | 70% | 28% | 67 | 1,927,200 |
| C3 | 405 | 310 | 340 | 84% | 67% | 208 | 2,978,400 |
| C4 | 225 | 175 | 170 | 76% | 44% | 77 | 1,489,200 |
| C5 | 135 | 110 | 100 | 74% | 42% | 46 | 876,000 |
| Total | 1,350 | 1,035 | 1,060 | | | 538 | 9,285,600 |

| | |
|---|---|
| Rated TR/kW efficiency | 0.7667 |
| Actual TR/kW efficiency | 0.5076 |
| Efficiency reduction | 34% |

HIGH STAGE

| | FULL | | ACTUAL | % | % | | |
|---|---|---|---|---|---|---|---|
| | LOAD | TR | LOAD | ELECTRIC | TR | ACTUAL | |
| COMP. # | kW | RATING | kW | LOAD | LOAD | TR | kWhrs/year |
| C6 | 540 | 550 | 350 | 65% | 51% | 281 | 3,066,000 |
| C7 | 630 | 630 | 350 | 56% | 40% | 252 | 3,066,000 |
| C8 | 630 | 650 | 400 | 63% | 49% | 319 | 3,504,000 |
| C9 | 540 | 570 | 300 | 56% | 40% | 228 | 2,628,000 |
| C10 | 405 | 480 | 200 | 49% | 0% | — | 1,752,000 |
| Total | 2,745 | 2,880 | 1,600 | | | 1,079 | 14,016,000 |

| | |
|---|---|
| Rated TR/kW efficiency | 1.0492 |
| Actual TR/kW efficiency | 0.6744 |
| Efficiency reduction | 36% |

COMBINED TOTAL

| | |
|---|---|
| TOTAL DESIGN TR RATING | 3,915 |
| TOTAL DESIGN KW RATING | 4,095 |
| TOTAL ACTUAL TR | 1,617 |
| TOTAL ACTUAL KW | 2,660 |
| TR RATIO - ACTUAL/DESIGN | 41% |
| KW RATIO - ACTUAL/DESIGN | 65% |

CONDENSER FANS

| | FULL | ACTUAL | % | |
|---|---|---|---|---|
| | LOAD | LOAD | ELECTRIC | |
| | kW | kW | LOAD | kWhrs/year |
| CON # 1 | 54 | 54 | 100% | 473,040 |
| CON # 2 | 45 | 45 | 100% | 394,200 |
| CON # 3 | 45 | 45 | 100% | 394,200 |
| CON # 4 | 36 | 0 | 0% | — |
| CON # 5 | 54 | 54 | 100% | 473,040 |
| CON # 6 | 45 | 0 | 0% | — |
| Total | 279 | 198 | | 1,734,480 |

| | |
|---|---|
| TOTAL TONNAGE HOUR OF REFRIGERATION | 14,165,796 |
| TOTAL ENERGY CONSUMPTION | 25,036,080 |

### 3. Cooling System 22 Under Control of Control System 24:

FIG. 1 is a schematic representation of the two-stage industrial refrigeration system in the same meat processing and packing facility as described in FIG. 1 & chapter 2 above but retrofitted with the instruments and control system 24.
3.1. The controller 24 receives the following analog inputs from the various equipment and surrounding ambience of the refrigeration system:
   3.1.1. Low stage gas temperature from low stage gas suction tank 40, through transmitter 68.
   3.1.2. Low stage gas pressure from low stage gas suction tank 40, through transmitter 60.
   3.1.3. High stage gas temperature from high stage gas suction tank 34, through transmitter 70.
   3.1.4. High stage gas pressure from High stage gas suction tank 34, through transmitter 62.
   3.1.5. Refrigerant flow, from the holding tank 30, through transmitter 78.
   3.1.6. Refrigerant temperature from the holding tank 30, through transmitter 64.
   3.1.7. Refrigerant flow from the suction tank 34, through transmitter 80.
   3.1.8. Refrigerant temperature from the suction tank 34, through transmitter 66.
   3.1.9. Temperature of condensation from the holding tank 30, through transmitter 76.
   3.1.10. Pressure of condensation from the holding tank 30, through transmitter 63.
   3.1.11. Condenser water outlet flow from the outlet water line 75, through transmitter 84.
   3.1.12. Condenser water outlet temperature from the outlet water line 75 through transmitter 74.
   3.1.13. Condenser water/air inlet flow from the inlet or suction water or air line 73 through transmitter 82.
   3.1.14. Condenser water/air inlet temperature from the inlet water line 73, through transmitter 72.
   3.1.15. Ambient vet bulb temperature from the ambience through transmitter 88.
   3.1.16. Ambient dry bulb temperature from the ambience through transmitter 90.
3.2. The controller receives the following data inputs from the operator:
   3.2.1. Compressor list including compressor kW, TR rating, service factor, start delay, rest delay, stop delay etc
   3.2.2. Volume of each system in which the respective refrigerant (both gas and liquid) is contained.
   3.2.3. The type of refrigerant used
   3.2.4. Various operational parameters such as system set temperature, pressure, etc., for each stage.
   3.2.5. Set levels of the liquid in various refrigerant liquid holding tank
   3.2.6. Internal size and geometry of the holding tank
   3.2.7. Over riding set points
   3.2.8. Critical limit of the Variable Frequency drive/s
   3.2.9. Any other inputs not covered above but required by the design
3.3. The controller sends out the following digital & analog output signals:
   3.3.1. Start/stop/load/unload/modulate signals to the compressor motors
   3.3.2. Frequency variation signal to the frequency drive for the compressors
   3.3.3. Set points of pressures to the high stage suction tank and discharge of high stage compressors
   3.3.4. Frequency variation signal to the frequency drive for the fans
   3.3.5. Any other output not covered above but required by the design

### 4. Control Strategy of Control System 24

Almost all of the industrial and or commercial refrigeration and air conditioning systems are controlled for maintaining one or more of the following physical conditions:
4.1. Control Parameter/s
   4.1.1. Comfort Temperature—Building Air conditioning
   4.1.2. Statutory Temperature Levels—Cold storages and ware houses
   4.1.3. Process Temperature—Food Processing
   4.1.4 Surrounding Humidity Level—Food processing and Textile mills, printing industry etc
   4.1.5. Cooling Rate required for the process—Food industry
   4.1.6. Chilled water or glycol temperature—All industrial facilities which require indirect cooling for processes; e.g. plastic molding, forming, extrusion industry; hydraulic presses etc.

The control parameters described above are all based on temperature bands. For e.g. if the temperature goes up beyond the temperature band the control if any will start compressing more refrigerant gas, condense and circulate for evaporation to reduce the temperature. Similarly, when the temperature falls below the band, it will reduce the amount of gas compressed, condensed, and circulated for evaporation.

The refrigerant liquid and vapor will be at equilibrium at the saturation temperature. There is only one saturation temperature corresponding to a particular pressure. Therefore if you control the pressure you can control the temperature. Therefore, most users of refrigeration systems, in a bigger scale, control the pressure to control the temperatures.

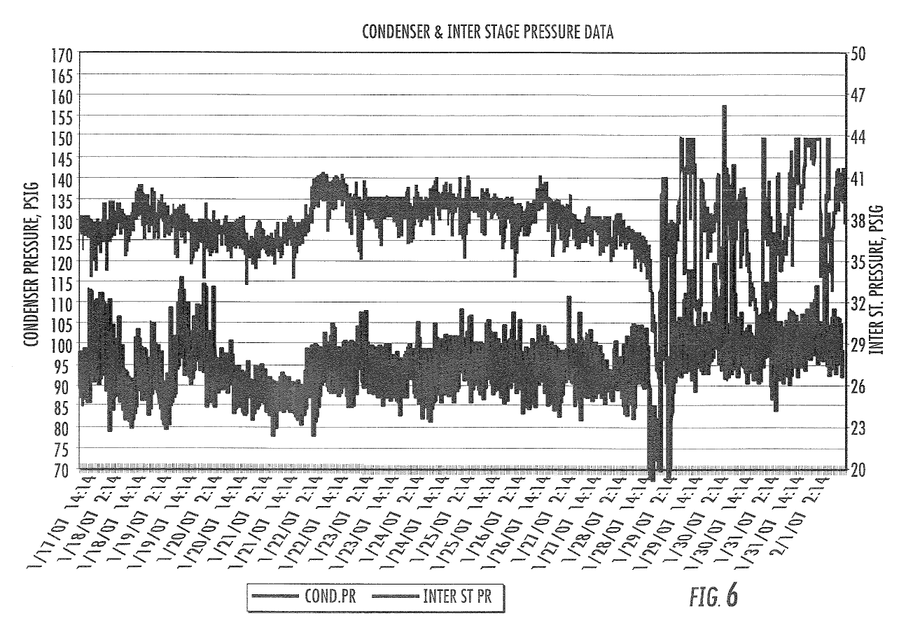

The trending (ups and downs) of temperature does not follow a predictable pattern in a continuous process industry especially when the process conditions vary dramatically. The unpredictability is even more severe in a refrigeration system which is influenced by ambient temperature and relative humidity. FIGS. 3, 4 and 5 illustrate this phenomenon very clearly. See FIG. 6 also:

Therefore, maximum number of compressing, condensing and circulation equipment is run to satisfy the temperature set points all the time irrespective of the actual refrigeration thermal load. For e.g. in the system described in Table 2.1, compressors of total capacity of 3,915 Tons are run to a refrigeration thermal load of 1,617 Tons. The capacity utilization is only 41%. However the electric power consumption is 2,660 kW OR 65% of the running compressors' full load motor power of 4,095 kW. There is an efficiency reduction of 36% because of the partial loading.

The present invention relates to the control of refrigeration fluids during the stages of compression, condensation, distribution to optimize energy efficiency performance of the compressors, cooling fans, distribution pumps etc. of the refrigerant fluids and the carrier of cooling or heating energy like water or air, pumping or blowing systems for the cooling mediums of the refrigerants, and all the above energy performance obtainable without affecting the associated process integrity.

The optimum energy efficiency of these stages is achieved simply by including the thermal load and the ambient conditions as additional control parameters to the process temperatures.
4.2. Control Logic:
The following steps are included in the algorithm of controller 94.
   4.2.1. Refrigerant vapor pressure and temperatures are dynamically measured at least in one holding tank of each stage (1^{st}, stage suction, 2^{nd}, stage suction & condenser etc.).
   4.2.2. Total Refrigerant flow to the system from the holding tank 30 is measured.
   4.2.3. Total Refrigerant flow to the low stage system from the holding tank 34 is measured.
   4.2.4. Total Water consumption by the condensers is measured
   4.2.5. The ambient wet bulb and dry bulb temperatures are measured
   4.2.6. Full Load “Tonnage Hour” (TR) capacity of each refrigeration compressor in the system is listed in a table; the TR may be either measured or chosen from the manufacturers published data
   4.2.7. Operating Power (kW) of each individual compressor is continuously measured
   4.2.8. From chapters 4.2.1 through 4.2.7 the following calculations and validations are conducted
      4.2.8.1. Total instant heat loads are computed from the measured flow, temperature and pressures of the refrigerant
      4.2.8.2. The computed heat load is validated by the heat load absorbed by the cooling water and/or the cooling air flow.
   4.2.9. Chapters 4.2.8.1 and 4.2.8.2 can be interchanged depending on the in situ conditions.
   4.2.10. From the pressure and temperature changes, the rate of change of mass and enthalpies are computed.
4.3. From chapter 4.2.8 actual instant refrigeration demand is computed
4.4. From chapter 4.2.10 rate of change refrigeration demand is determined
4.5. From chapters 4.3 & 4.4 the total refrigeration demand in the immediate future is determined
4.6. The refrigeration demand determined by Item 4.5 will be mapped with the Capacity Tables 5.1 & 5.2 in chapter five to select the optimum number of compressors to be fully loaded and the one compressor to be partially loaded or trimming in each stage.
4.7. The compressors selected for full load in Item 4.5 will have the inlet ports completely open. For e.g. if the inlet port is controlled by slide valve, the slide valve will be in a 100% closed position allowing the inlet port area to be 100% open to the suction reservoir.
4.8. The compressor selected for trim or partial load in chapter 4.6 will be controlled by either partial opening and closing the inlet ports by available means or by an external variable electrical frequency mechanism that will increase or decrease speed of the motor shaft of the selected trim compressor.
4.9. Chapters 4.7 & 4.8 enable to select the optimum number compressors to be in operation to the current and instantly changing refrigeration load
   To summarize, steps 4.1 through 4.9, the controller dynamically determines the following:
The instant thermal load
The dynamic rate of change of thermal load
The response time
The immediate future thermal load
Selection of the compressors to be fully loaded in each stage
Selection of the trim compressor for each stage
Time available to add or remove compressor
Condenser fan speed
The number of condensers effectively transferring the heat to the atmosphere
4.10. The other compressor operating parameters are the suction and discharge pressures.
   4.10.1. The suction pressure in each stage is influenced by the process temperature requirements
   4.10.2. The intermediate stage suction pressure may be optimized as a function of the condensing pressure and lowest suction pressure of the system.
   4.10.3. The intermediate stage pressure can be configured as a choice by the user between item 4.10.1 and 4.10.2
   4.10.4. The condensing pressure is influenced by the ambient wet bulb temperatures; for a constant condensing surface area, the condensing pressure will fall as the ambient wet bulb temperature falls; therefore the condensing pressure can be set as dynamic set point which will be determined by the control program as a function of the ambient wet bulb temperature and an allowable tolerance in temperature.
   4.10.5. Some processes require minimum level of pressures for the liquid refrigerant holding tank for effective pumping or for defrosting purposes.
   4.10.6. The condensing pressure can be maintained at a minimum level within a set band of pressures by reducing condensing surface area and or by shutting of the condenser fans in case of item 4.10.5.
   4.10.7. Controller 24 described above provides a chance to the operator to select the minimum condensing pressure for optimum energy efficiency and at the same time, satisfying process condition described in item 4.10.5.
4.11. Chapters 4.9 & 4.10 will enable optimizing the refrigeration compressors' operation.
4.12. The volume of air to be forced by the evaporative condenser fan is also a function of the heat load to be removed.
4.13. Chapter 4 5 will determine the speeds of the fans to be operated with installed variable frequency mechanism

### 5. Control Algorithm

FIG. 2 is block diagram of the control logic of controller 94.
5.1. Analog inputs (FIG. 2 #300) are fed in to the controller. They include but not limited to the following:
   5.1.1. Low stage gas; temperature from low stage gas suction
   5.1.2. Low stage gas; pressure from low stage gas suction tank
   5.1.3. High stage gas temperature from high stage gas suction tank
   5.1.4. High stage gas pressure from High stage gas suction tank
   5.1.5. Refrigerant flow from the holding receiver
   5.1.6. Refrigerant temperature from the holding receiver.
   5.1.7. Refrigerant flow from the high stage suction tank
   5.1.8. Refrigerant temperature from the high stage suction tank
   5.1.9. Temperature of condensation from the holding receiver.
   5.1.10. Pressure of condensation from the holding tank receiver.
   5.1.11. Condenser water outlet flow from the outlet water line
   5.1.12. Condenser water outlet temperature from the outlet water line
   5.1.13. Condenser water/air inlet flow from the inlet water/suction line
   5.1.14. Condenser water/air inlet temperature from the outlet line
   5.1.15. Ambient wet bulb temperature
   5.1.16. Ambient dry bulb temperature
5.2. The operator enters all the operating data (FIG. 2 #301). The data includes but is not limited to the following:
   5.2.1. Compressor list including compressor kW, TR rating, service factor, start delay, rest delay, stop delay etc
   5.2.2. Volume of each system in which the respective refrigerant (both gas and liquid) is contained.
   5.2.3. The type of refrigerant used
   5.2.4. Various operational parameters such as system set temperature, pressure, etc., for each stage.
   5.2.5. Set levels of the liquid in various refrigerant liquid holding tank
   5.2.6. Internal size and geometry of the holding tank
   5.2.7. Over riding set: points
   5.2.8. Critical limit of the Variable Frequency drive/s
5.3. Dynamic Load Balancing
Controller computes the dynamic operational parameters (FIG. 2 #302). They include but not limited to the following:
   5.3.1. Thermal load on the condenser—From mass flow difference of air/water and temperature difference between inlet and outlet
   5.3.2. Thermal load clue to heat of compression
   5.3.3. Thermal load of refrigeration—Thermal load of condenser minus heat of compression
   5.3.4. Determine enthalpies of liquid and gas at various stages—From formula or Look up table for the analog input of pressure and temperature in each stage
   5.3.5. Validate Thermal load—From refrigerant flow measurements * enthalpies and steps 5.3.1 through 5.3.3.
   5.3.6. Volume of gas—Total Volume minus the liquid volume
   5.3.7. Density of gas—From formula or Look up table for the analog input of pressure and temperature in each stage
   5.3.8. Calculate instant mass of gas in each stage—from formula “Mass in lbs=d*V” Where d=density in lbs/cubic feet, of the gas at the measured temperature & pressure and V=Total volume in cubic feet occupied by the evaporated gas.
   5.3.9. The rate of change of mass/second equals the change of refrigerant flow in lbs/second
   5.3.10. Available Response time—From gas volume and rate of change of gas mass
   5.3.11. Practical Response time From 5.3.10 and compressor operational parameters
   5.3.12. Total refrigerant flow—Instant flow plus refrigerant flow during the response time
   5.3.13. The refrigeration load on the compressors of both stages—Total refrigerant (lbs/min) recirculated as measured by flow transmitter 78 multiplied by (*) enthalpy (btu/lb) of the refrigerant at the instant temperature as transmitted measured by temperature transmitter 64 from the look up table or by calculation.
   5.3.14. The refrigeration load on the compressors (42) of the low stage—Total refrigerant (lbs/min) flowing to the expansion valve 53 as measured by flow transmitter 80 multiplied by (*) enthalpy (btu/lb) of the refrigerant at the instant temperature as transmitted measured by temperature transmitter 66 from the look up table or by calculation.
   5.3.15. The refrigeration load on the compressors (44) of the high stage equals the enthalpy as computed in chapter 5.3.13 minus the enthalpy as computed in chapter 5.3.14.
5.4. Selection Of Compressors & Condenser Fan Speeds
The controller decides the actions. They include but not limited to the following:
   5.4.1. Identifies and selects the number of compressors for full loads (FIG. 2 #303)—From the operator data (FIG. 2 #301) and chapter 5.3.14 & 5.3.15. For e.g., in the facility under FIG. 1 and chapter 4.0 above, the refrigeration thermal loads are 538 and 1,079 Tons in the low and high stage respectively. The nearest full load capacity to thermal load is of compressor C1 & C3 in the low stage and of compressor C8 in the high stage respectively as evident from the compressor tables below;

TABLE 5.1
LOW STAGE

| | HP | FULL LOAD | TR |
|---|---|---|---|
| COMPRESSOR # | RATING | KW | RATING |
| [symbol] | [symbol] | [symbol] | [symbol] |
| C2 | 350 | 315 | 240 |
| [symbol] | [symbol] | [symbol] | [symbol] |
| C4 | 250 | 225 | 175 |
| C5 | 150 | 135 | 110 |

TABLE 5.2
HIGH STAGE

| | HP | FULL LOAD | TR |
|---|---|---|---|
| COMPRESSOR # | RATING | KW | RATING |
| C6 | 600 | 540 | 550 |
| C7 | 700 | 630 | 630 |
| [symbol] | [symbol] | [symbol] | [symbol] |
| C9 | 600 | 540 | 570 |
| C10 | 450 | 405 | 480 |

5.4.2. Controller 94 computes the balance thermal capacity required by the process as 18 Tons in the Low stage and 429 Tons in the high stage; accordingly it selects the trim compressors (FIG. 2 #303) C5 in the low stage, and C10 in the high stage because they have the nearest higher capacity to the short fall to meet the demand in the low and high stages respectively.
5.4.3. Computes the most efficient way (FIG. 2 #304) of operating the trim compressors; either by mechanically controlling the inlet volume (FIG. 2 #307) or by varying the speed of the motor shaft through the Variable frequency drive (FIG. 2 #306).
5.4.4. CONDENSER FANS' SPEED:
   5.4.4.1. Condenser fans force the air to the outside of the condenser coils to carry the condenser thermal load to the atmosphere and improve the heat transfer efficiency. Since the amount of air to be circulated depends on the thermal load, the controller per the present invention Varies the speeds of the fans uniformly (through a common variable frequency drive for all the fans) to match with the thermal load. In the process it also checks the critical speed of the fans. If computed speed is less than the critical speed of the fans, the controller reduces the number of condensers on line to obtain the best energy efficiency of operation.
   See Table 5.3:

TABLE 5.3
CONDENSER FANS

| | FULL | ACTUAL | % | |
|---|---|---|---|---|
| | LOAD | LOAD | ELECTRIC | |
| | kW | kW | LOAD | kWhrs/year |
| CON # 1 | 54 | 27.648 | 80% | 242,196 |
| CON # 2 | 45 | 23.04 | 80% | 201,830 |
| CON # 3 | 45 | 23.04 | 80% | 201,830 |
| CON # 4 | 36 | 0 | 0% | — |
| CON # 5 | 54 | 0 | 0% | — |
| CON # 6 | 45 | 0 | 0% | — |
| Total | | 73.728 | | 645,857 |

### 6. Energy Analysis Of System 22 Under Control System 24

Table 6.1 summarizes the energy analysis of the example facility in chapter 2 and FIG. 1, after retrofitted with control system 24 and according to FIG. 1 and described in chapters 4 and 5.

TABLE 6.1
ENERGY ANALYSIS - CURRENT INVENTION
LOW STAGE

| | FULL | | ACTUAL | % | % | | |
|---|---|---|---|---|---|---|---|
| | LOAD | TR | LOAD | ELECTRIC | TR | ACTUAL | |
| COMP. # | kW | RATING | kW | LOAD | LOAD | TR | kWhrs/year |
| C1 | 270 | 200 | 270 | 100% | 100% | 200 | 2,365,200 |
| C2 | 315 | 240 | 0 | 0% | 0% | — | — |
| C3 | 405 | 310 | 405 | 100% | 100% | 310 | 3,547,800 |
| C4 | 225 | 175 | 40 | 18% | 16% | 28 | 351,651 |
| C5 | 135 | 110 | 0 | | | | — |
| Total | 1,350 | 1,035 | 715 | | | 538 | 6,264,651 |

| | |
|---|---|
| Rated TR/kW efficiency | 0.7667 |
| Actual TR/kW efficiency | 0.7524 |
| Efficiency reduction | 2% |

HIGH STAGE

| | FULL | | ACTUAL | % | % | | |
|---|---|---|---|---|---|---|---|
| | LOAD | TR | LOAD | ELECTRIC | TR | ACTUAL | |
| COMP. # | kW | RATING | kW | LOAD | LOAD | TR | kWhrs/year |
| C6 | 540 | 550 | | | | | — |
| C7 | 630 | 630 | | | | | — |
| C8 | 630 | 650 | 630 | 100% | 100% | 650 | 5,518,800 |
| C9 | 540 | 570 | | | | | — |
| C10 | 405 | 480 | 419 | 99% | 89% | 429 | 3,669,961 |
| Total | 2,745 | 2,880 | 1,049 | | | 1,079 | 9,188,761 |

| | |
|---|---|
| Rated TR/kW efficiency | 1.0492 |
| Actual TR/kW efficiency | 1.0287 |
| Efficiency reduction | 2% |

COMBINED TOTAL

| | |
|---|---|
| TOTAL DESIGN TR RATING | 3,915 |
| TOTAL DESIGN KW RATING | 4,095 |
| TOTAL ACTUAL TR | 1,617 |
| TOTAL ACTUAL KW | 1,764 |
| TR RATIO - ACTUAL/DESIGN | 41% |
| KW RATIO - ACTUAL/DESIGN | 43% |

CONDENSER FANS

| | FULL | ACTUAL | % | |
|---|---|---|---|---|
| | LOAD | LOAD | ELECTRIC | |
| | kW | kW | LOAD | kWhrs/year |
| CON # 1 | 54 | 27.648 | 80% | 242,196 |
| CON # 2 | 45 | 23.04 | 80% | 201,830 |
| CON # 3 | 45 | 23.04 | 80% | 201,830 |
| CON # 4 | 36 | 0 | 0% | — |
| CON # 5 | 54 | 0 | 0% | — |
| CON # 6 | 45 | 0 | 0% | — |
| Total | | 73.728 | | 645,857 |

| | |
|---|---|
| TOTAL TONNAGE HOUR OF REFRIGERATION | 14,165,796 |
| TOTAL ENERGY CONSUMPTION | 16,099,270 |

6.1. The energy saving obtainable by optimization of the supply and demand of the “REFRIGERATION LOAD” with the retrofit of the controller and accessories as described by the Current invention is summarized as below:

### Summary of Savings

PRIOR ART

| | | |
|---|---|---|
| TOTAL TONNAGE HOUR OF | 14,165,796 | TONS/YEAR |
| REFRIGERATION | | |
| TOTAL ENERGY CONSUMPTION | 25,036,080 | KWHRS/YEAR |

CURRENT INVENTION

| | | |
|---|---|---|
| TOTAL TONNAGE HOUR OF | 14,165,796 | TONS/YEAR |
| REFRIGERATION | | |
| TOTAL ENERGY CONSUMPTION | 16,099,270 | KWHRS/YEAR |
| ENERGY SAVINGS | 8,936,810 | KWHRS/YEAR |
| PERCENTAGE OF SAVING | 36% | |

### 7. Optimization of System Parameters:

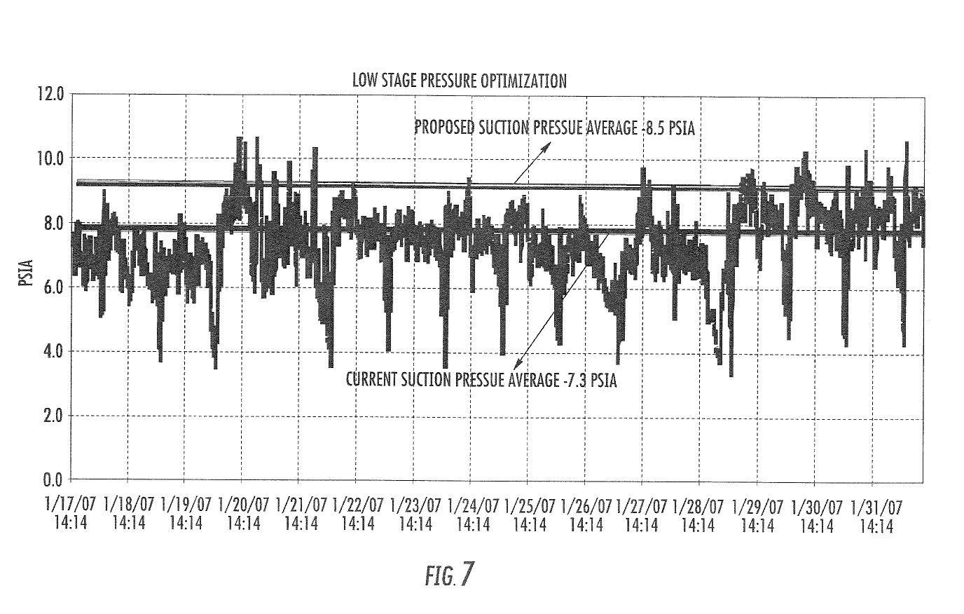

The controller and equipment per the current invention is capable of producing more energy saving in addition to the energy saving obtainable in chapter 7.1, by optimizing the system operational parameters to match with the need and talking advantage of the natural atmospheric conditions.
7.1. LOW STAGE SUCTION PRESSURE:
   7.1.1. Low stage process requires a temperature of minus forty five (−45 F) degree Fahrenheit, corresponding to a saturation pressure (of Ammonia refrigerant) of 8.92 PSIA. The compressors are set to maintain a suction pressure of 8.0 PSIA (corresponding to a saturation temperature of −48.5 F), in the low stage suction tank 40. FIG. 3 shows the actual pressure reading in the tank 40 over a period of fifteen days.
   7.1.2. The controller per the current invention is capable of controlling within a tighter band of suction pressure without compromising the required temperature of minus (−) 45 degrees F. see FIG. 7. This is achieved solely due to the pro-active ability of the controller to accurately predict the thermal load changes and thereby the temperature changes. The resultant energy savings in this example can be as high as two percentage points (2%) of the power for the corresponding compressors.
7.2 HIGH STAGE COMPRESSORS:
   High stage process requires a temperature of 17 degree Fahrenheit (F), corresponding to a saturation pressure (of Ammonia refrigerant) of 45 PSIA (˜30 PSIG).
   7.2.1. As described in Chapter 2, and FIG. 1, the high stage compressors are set to maintain a suction pressure of 30 PSIG (corresponding to a saturation temperature of 17 F), in the high stage suction tank for all seasons and conditions through out the year. It does not take advantage of ambient conditions to maximize the energy efficiency of the compressors.
   7.2.2. The controller per the present invention described in Chapter 4 and FIG. 2, is designed and programmed to change the inter stage suction pressure (which is also the low stage compressors' discharge pressure) for optimizing the energy efficiency of the refrigeration compressors. In other words the inter stage pressure is not fixed set point as in the prior art. The optimum inter stage pressure (as far as the energy efficiency is concerned) is obtained by the following formula:

P2=Square Root of P1(Low stage suction pressure)*P3 (Condensing Pressure),

where,

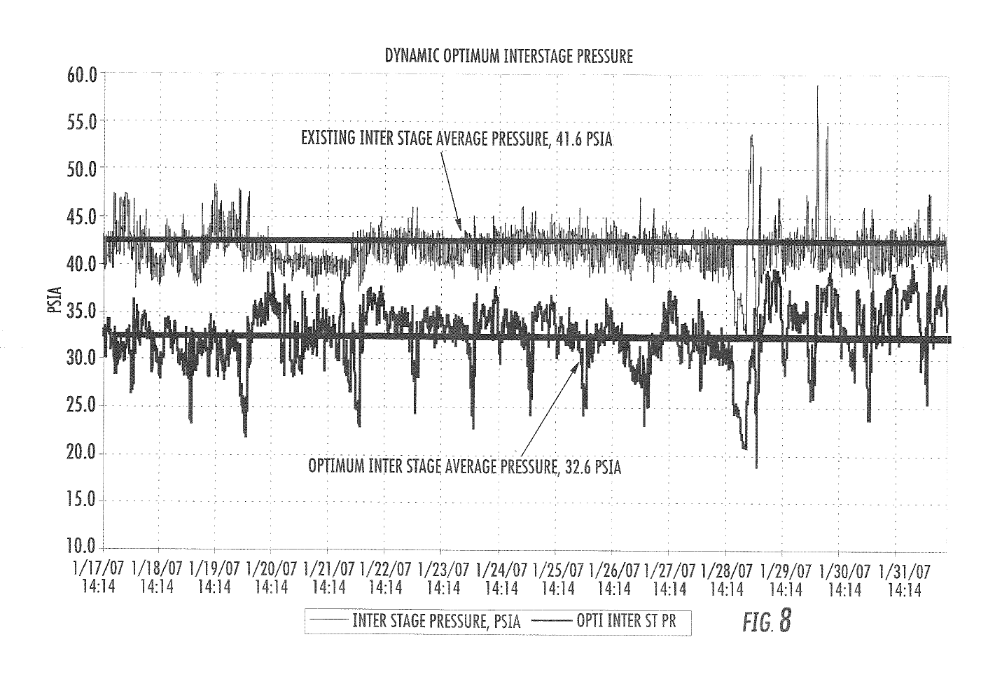

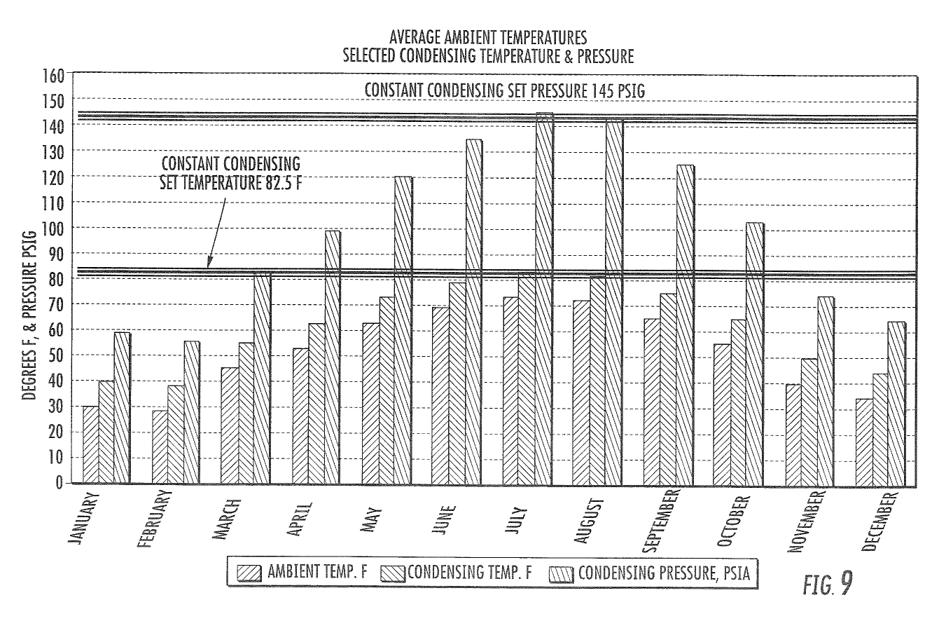

P1=Low stage suction pressure in PSIA, P2=Inter stage pressure in PSIA, and P3=condensing pressure in PSIA.
7.2.3. The inter stage pressure is made dynamic because the condensing pressure is made dynamic as described in chapter 7.3 following this chapter.
7.2.4. FIG. 8 shows the dynamic inter stage pressure as calculated by the controller as against the variations of the fixed suction pressure set by the controller of the prior art.
7.2.5. The resultant energy savings in this example can be as high as two percentage points (2%) per one PSI reduction in the inter stage pressure. The energy savings can be as high as 18% in this example.
7.2.6. The controller is also configured to provide the operator with the chance to select the floating dynamic set pressure calculated in chapter 7.2.2 or a mandatory set pressure required by the intermediate stage cooling loads.
7.3. CONDENSING PRESSURE:
   The condensation temperature depends on the ambient temperature and humidity in an evaporative condenser. The lower the wet bulb temperature, the lower would be the condensing temperature. When the condensing temperature is lower the condensing pressure also can be lower. If the condensing pressure is lower, the high stage compressors need to do less amount of compression and therefore less energy consumption.
   The controller per the current invention capitalizes on the above natural phenomenon and can dynamically set the condensing pressure dependent on the ambient conditions.
   7.3.1. AVERAGE AMBIENT CONDITIONS:
      FIG. 9 depicts the monthly average ambient temperatures measured for the facility per the prior art described in the chapter 2. The chart also includes the constant condensing temperature and pressure as set by the controller in the prior art.
      It also shows the condensing temperature and the corresponding condensing pressure as set by the controller 94.
   7.3.2. POTENTIAL SAVING:

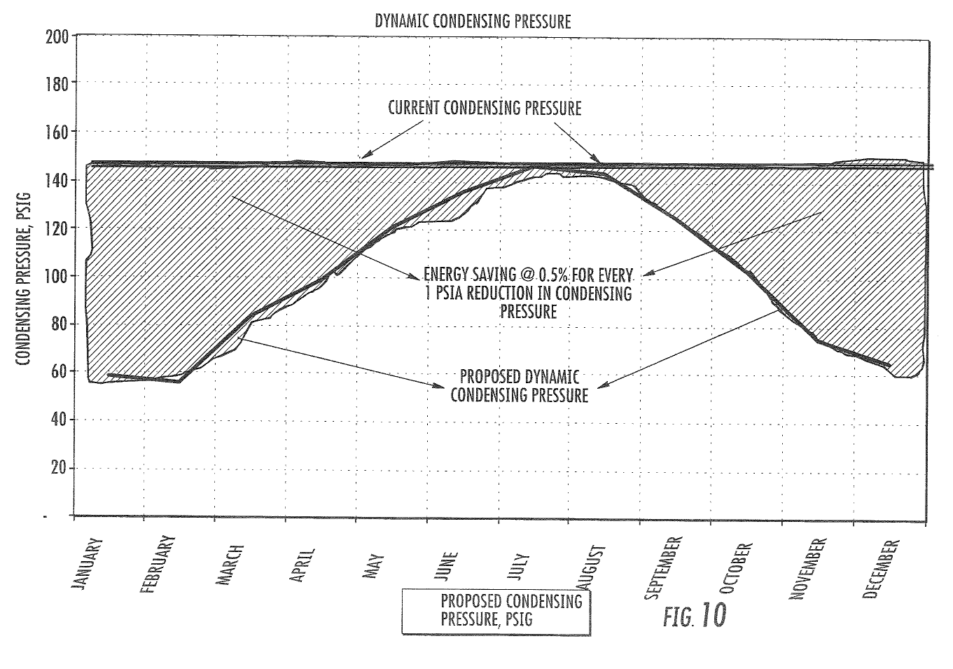

FIG. 10 depicts the potential saving effect by varying the condensing pressure as per the ambient temperature as shown in FIG. 9. The savings can be as high as twenty percentage points of the energy consumption of the prior art.

The ambient wet and dry bulb temperatures will be measured constantly. From the temperatures and using psychometric charts and formulas the condensing pressure will be computed by the controller 94 as described in chapter 4-Control Strategy of Control System 24 and chapter 5-CONTROL ALGORITHM and FIG. 2.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a controller configured to perform at least one of loading and unloading at least one of a plurality of refrigerant compressors to a refrigeration cooling system based at least upon an enthalpy of circulating refrigerant liquid of the refrigeration cooling system and a rate of change of enthalpy of evaporated refrigerant gas in the refrigeration cooling system.

2. The apparatus of claim 1, wherein the controller is configured to adjust one or more operational parameters of a condenser of the refrigeration cooling system based on enthalpy of circulating refrigerant liquid of the refrigeration cooling system and a rate of change of enthalpy of evaporated refrigerant gas in the refrigeration cooling system.

3. The apparatus of claim 1, wherein the controller is configured to adjust a sampling rate at which the rate of change of enthalpy is determined based on the enthalpy of circulating refrigerant liquid of the refrigeration cooling system and a rate of change of enthalpy of evaporated refrigerant gas in the refrigeration cooling system.

4. The apparatus of claim 1, wherein the controller is configured such that no more than one compressor of the refrigeration cooling system is in an unloading or partial loading mode at any moment in time.

5. The apparatus of claim 1, wherein the controller is configured such that only one compressor of the refrigeration cooling system is partially loaded at any moment in time.

6. The apparatus of claim 1, wherein the controller is configured to determine the enthalpy based on sensed flow of liquid refrigerant and at least one of a temperature and a pressure of the liquid refrigerant.

7. The apparatus of claim 1, wherein the controller is configured to determine the rate of change of enthalpy based upon at least one of pressure and temperature of gaseous refrigerant in the refrigeration cooling system and a volume of the gaseous refrigerant at different times.

8. The apparatus of claim 1, wherein loading and unloading of the at least one of the plurality of compressors is based on a lead time for starting and loading the at least one of the plurality of compressors.

9. The apparatus of claim 1 further comprising the refrigeration cooling system, wherein the refrigeration cooling system comprises:
first compressors configured to receive gaseous refrigerant;
a condenser configured to receive gaseous refrigerant from the first compressors;
a first refrigerant evaporator configured to receive liquid refrigerant from the condenser;
a first flow sensor configured to sense flow of the liquid refrigerant;
a first one of a pressure sensor or a temperature sensor configured to sense pressure or temperature of the liquid refrigerant; and
a second one of a pressure sensor or a temperature sensor configured to sense pressure or temperature of gaseous refrigerant between the first evaporator and the first compressors.

10. The apparatus of claim 9, wherein the refrigeration cooling system further comprises:
a second evaporator configured to receive liquid refrigerant from the condenser;
second compressors configured to receive gaseous refrigerant from the second evaporator;
a second flow sensor configured to sense flow of the liquid refrigerant;
a third one of a pressure sensor or a temperature sensor configured to sense pressure or temperature of the liquid refrigerant; and
a fourth one of a pressure sensor or a temperature sensor configured to sense pressure or temperature of gaseous refrigerant between the second evaporator and the second compressors.

11. A method comprising:
performing at least one of loading and unloading at least one of a plurality of refrigerant compressors to a refrigeration cooling system based at least upon an enthalpy of circulating refrigerant liquid of the refrigeration cooling system and a rate of change of enthalpy of evaporated refrigerant gas in the refrigeration cooling system.

12. The method of claim 11 further comprising adjusting one or more operational parameters of a condenser of the refrigeration cooling system based on enthalpy of circulating refrigerant liquid of the refrigeration cooling system and a rate of change of enthalpy of evaporated refrigerant gas in the refrigeration cooling system.

13. The method of claim 11 further comprising adjusting a sampling rate at which the rate of change of enthalpy is determined based on the enthalpy of circulating refrigerant liquid of the refrigeration cooling system and a rate of change of enthalpy of evaporated refrigerant gas in the refrigeration cooling system.

14. The method of claim 11, wherein no more than one compressor of the refrigeration cooling system is in an unloading or partial loading mode at any moment in time.

15. The method of claim 11, wherein only one compressor of the refrigeration cooling system is partially loaded at any moment in time.

16. The method of claim 11, wherein the enthalpy is determined based on sensed flow of liquid refrigerant and at least one of a temperature and a pressure of liquid refrigerant of the refrigeration cooling system.

17. The method of claim 11, wherein the rate of change of enthalpy is determined based upon at least one of pressure and temperature of evaporated refrigerant gas in the refrigeration cooling system and a volume of the refrigerant gas at different times.

18. The method of claim 11, wherein the loading and unloading of the at least one of the plurality of compressors is based on a lead time for starting and loading the at least one of the plurality of compressors.

19. The method of claim 11 further comprising adjusting one or more operational parameters of a condenser of the refrigeration cooling system based on ambient temperatures, enthalpy of circulating refrigerant liquid of the refrigeration cooling system and a rate of change of enthalpy of evaporated refrigerant gas in the refrigeration cooling system.

20. A method comprising:
controlling one or more operational parameters of a condenser of a refrigeration cooling system based on enthalpy of circulating refrigerant liquid of the refrigeration cooling system, a rate of change of enthalpy of evaporated refrigerant gas in the refrigeration cooling system and ambient temperature or humidity.

21. The method of claim 20, wherein the controlling of the one or more parameters of the condenser is based on an established minimum refrigerant gas pressure value.

22. A method comprising:
drawing refrigerant gas from a first tank to a first stage of compressors;
delivering refrigerant from the first stage of compressors to a second tank;
drawing refrigerant gas from the second tank to a second stage of compressors;
condensing refrigerant gas discharged from the second stage of compressors; and
controlling pressure in the second tank based upon a condensing pressure and pressure of the first tank.

23. The method of claim 22, wherein the pressure in the second tank is maintained at a pressure substantially equal to a square root of the product of the condensing pressure and the pressure of the first tank.

24. A computer readable medium comprising:
computer readable instructions configured to direct one or more processing units to generate control signals configured to perform at least one of loading and unloading at least one of a plurality of refrigerant compressors to a refrigeration cooling system based at least upon an enthalpy of circulating refrigerant liquid of the refrigeration cooling system and a rate of change of enthalpy of evaporated refrigerant gas in the refrigeration cooling system.
